(19) United States
(12) Patent Application Publication
(10) Pub. No.: US 2005/0008861 A1
(43) Pub. Date: Jan. 13, 2005

(54) Silver comprising nanoparticles and related nanotechnology

(75) Inventors: Tapesh Yadav, Longmont, CO (US); Audrey Vecoven, Flines les Raches (FR)

Correspondence Address: FOLEY AND LARDNER;SUITE 500, 3000 K STREET NW, WASHINGTON, DC, 20007, US

(73) Assignee: NanoProducts Corporation

(21) Appl. No.: 10/740,521

(22) Filed: Dec. 22, 2003

Related U.S. Application Data
(60) Provisional application No. 60/485,420, filed on Jul. 8, 2003.

(51) Int. Cl. B32B 5/16; B32B 27/18; C08K 9/00

(52) U.S. Cl. 428/403; 428/328; 523/200

(57) ABSTRACT

Nanoparticles comprising silver and their nanotechnology-enabled applications are disclosed; doped metal oxides, silver comprising complex nanoparticle compositions, silver nanoparticles, methods of manufacture, and methods of preparation of products from silver comprising nanoparticles are presented; And anti-microbial formulations are discussed. Color photochromaticity and related applications are disclosed.

### RELATED APPLICATIONS

The present application claims benefit of provisional application No. 60/485,420 filed Jul. 8, 2003, which is hereby incorporated by reference in its entirety.

### BACKGROUND OF THE INVENTION

1. Field of the Invention

The present invention relates to methods of manufacturing submicron and nanoscale doped or undoped silver comprising powders, and nanotechnology applications of such powders.

2. Relevant Background.

Nanopowders in particular and sub-micron powders in general are a novel family of materials whose distinguishing feature is that their domain size is so small that size confinement effects become a significant determinant of the materials' performance. Such confinement effects can, therefore, lead to a wide range of commercially important properties. Furthermore, since they represent a whole new family of material precursors where conventional coarse-grain physiochemical mechanisms are not applicable, these materials offer unique combination of properties that can enable novel and multifunctional components of unmatched performance. Yadav et al. in U.S. Pat. No. 6,344,271 and in co-pending and commonly assigned U.S. Patent Application Nos. 09/638,977, 10/004,387, 10/071,027, 10/113,315, and 10/292,263, which along with the references contained therein are all hereby incorporated by reference in full, teach some applications of sub-micron and nanoscale powders.

### SUMMARY OF THE INVENTION

Briefly stated, the present invention involves the methods for manufacturing nanoscale doped or undoped silver oxides powders and applications thereof.

In one embodiment, the present invention provides nanoparticles of doped or undoped silver derived substances. In another embodiment, the present invention provides methods for manufacturing doped or undoped substances comprising silver. In another embodiment, the present invention provides nanostructured composites and coatings that comprise silver. In yet another embodiment, the invention provides anti-microbial substances for a variety of applications. In other embodiments, the invention describes novel catalysts and additives for a variety of applications such as chemical transformation and biomedical applications.

In another embodiment, the invention describes useful materials and/or devices for optical, sensing, thermal, biomedical, structural, superconductive, energy, security and other uses. In yet another embodiment, the invention provides methods for producing novel doped or undoped silver comprising nanoscale powders in high volume, low-cost, and reproducible quality.

The present invention provides unique and useful methods of implementing nanotechnology.

### BRIEF DESCRIPTION OF THE DRAWINGS

FIG. 1 shows an exemplary overall approach for producing submicron and nanoscale powders in accordance with the present invention.

### DETAILED DESCRIPTION OF THE PREFERRED EMBODIMENTS

This invention is generally directed to very fine powders of doped or undoped substances comprising silver (Ag). The scope of the teachings herein includes high purity powders. This invention is generally directed to powders with mean crystallite size less than 1 micron, and in certain embodiments less than 100 nanometers. Methods for producing and utilizing such powders in high volume, low-cost, and reproducible quality are also described.

Definitions

For purposes of clarity, the following definitions are provided to aid understanding of the description and specific examples provided herein:

“Fine powders”, as the term is used herein, are powders that simultaneously satisfy the following:
particles with mean size less than 100 microns and
particles with aspect ratio between 1 and 1,000,000.

For example, in some embodiments, fine powders are powders comprised of particles with a mean particle size less than 10 microns and with aspect ratios ranging from 1 to 1,000,000.

“Submicron powders”, as the term is used herein, are fine powders that simultaneously satisfy the following:
particles with mean crystallite size less than 1 micron, and
particles with aspect ratio between 1 and 1,000,000.

For example, in some embodiments, submicron powders are powders comprised of particles with a mean particle size less than 500 nanometers and with aspect ratios ranging from 1 to 1,000,000.

“Nanopowders” (or “nanosize powders” or “nanoscale powders” or “nanoparticles” or “nanophase powders” or “nanocrystals”), as the term is used herein, are fine powders that simultaneously satisfy the following:
particles with mean crystallite size less than 250 nanometers and
particles with aspect ratio between between 1 and 1,000,000.

For example, in some embodiments, nanopowders powders are powders comprised of particles with a mean particle size less than 100 nanometers and with aspect ratios ranging from 1 to 1,000,000.

“Domain size” as the term is used herein is the mean minimum dimension of the microstructure of a substance. It is, to illustrate, the diameter of a cluster or powder, the diameter of a fiber, the thickness of a film, and such.

“Mean crystallite size” as the term is used herein is the size calculated by Warren-Averbach method from the peak broadening of X-ray diffraction spectra of the powders. If the particle is amorphous or X-ray spectra of crystallites is not obtainable, the term refers to the equivalent spherical diameter calculated from the specific surface area of the powder.

“Pure powders,” as the term is used herein, are powders that have composition purity of at least 99.9 weight %. For example, in certain embodiments, the purity is at least 99.99 weight % by metal basis.

“Precursor,” as the term is used herein encompasses any raw substance. E.g., In certain embodiments in a liquid form, the precursor can be transformed into a powder of same or different composition. The term includes, but is not limited to, organometallics, organics, inorganics, solutions containing organometallics, dispersions, sols, gels, emulsions, and mixtures.

“Powder”, as the term used herein encompasses oxides, carbides, nitrides, chalcogenides, metals, alloys, and combinations thereof. The term includes hollow, dense, porous, semi-porous, coated, uncoated, layered, laminated, simple, complex, dendritic, inorganic, organic, elemental, non-elemental, composite, doped, undoped, spherical, non-spherical, surface functionalized, surface non-functionalized, stoichiometric, and non-stoichiometric forms and substances.

“Coating” (or “film” or “laminate” or “layer”), as the term is used herein encompasses any deposition comprising submicron and nanoscale powders. The term includes a substrate, surface, deposition, and a combination that is a hollow, dense, porous, semi-porous, coated, uncoated, simple, complex, dendritic, inorganic, organic, composite, doped, undoped, uniform, non-uniform, surface functionalized, surface non-functionalized, thin, thick, pretreated, post-treated, stoichiometric, and non-stoichiometric forms or morphologies.

“Coated powder” as the term is used herein encompasses any powder with any form of coating on the powder. The term includes hollow, dense, porous, semi-porous, partially coated, fully coated, island-type coated, chemically bonded, physically bonded, dispersed, diffuse, gradient, simple, complex, dendritic, inorganic, organic, composite, doped, undoped, uniform, non-uniform, surface functionalized, surface non-functionalized, thin, thick, pretreated, post-treated, stoichiometric, and non-stoichiometric forms or morphologies.

This invention is specifically directed to submicron and nanoscale powders comprising doped or undoped silver. Given the relative abundance of silver in earth crust and current limitations on purification technologies, it is expected that many commercially produced materials would have naturally occurring silver impurities. These impurities are expected to be below 100 parts per million and in most cases in concentration similar to other elemental impurities. Removal of such impurities does not materially affect the properties of interest to an application. For the purposes herein, powders comprising silver impurities wherein the silver is present in concentrations similar to other elemental impurities are excluded from the scope of this invention. However, it is emphasized that silver may be intentionally engineered into powders, possibly as a dopant, at concentrations of 100 ppm or less, and these are included in the scope of this invention.

In a generic sense, the invention teaches nanoscale powders, and in a more generic sense, submicron powders typically comprising at least 100 ppm by weight, in certain embodiments greater than 1 weight % by metal basis, and in certain embodiments greater than 10 weight % by metal basis of silver (Ag).

While several preferred embodiments for manufacturing nanoscale and submicron powders comprising silver are disclosed, for the purposes herein, the nanoscale or submicron powders may be produced by any method or may result as a byproduct from any process.

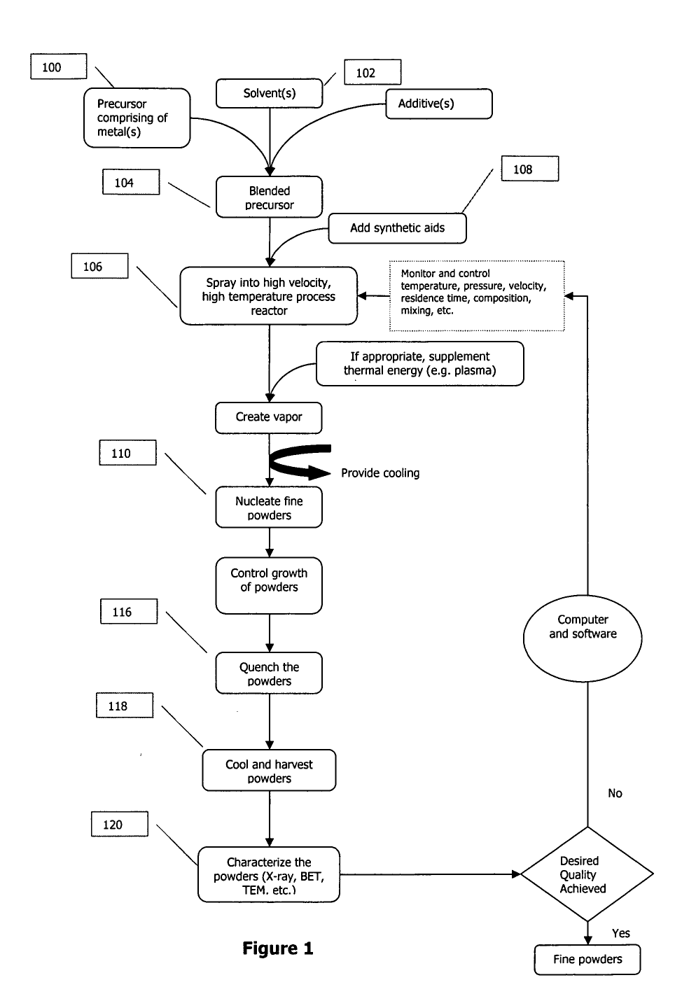

FIG. 1 shows an exemplary overall approach for the production of submicron powders in general and nanopowders in particular. The process shown in FIG. 1 begins with a silver containing raw material. Raw materials include, but are not limited to, coarse oxide powders, metal powders, salts, slurries, waste products, organic compounds, and inorganic compounds. FIG. 1 shows one embodiment of a system for producing nanoscale and submicron powders in accordance with the present invention.

The process shown in FIG. 1 begins at 100 with a silver metal-containing precursor such as an emulsion, fluid, particle-containing liquid slurry, or water-soluble salt. The precursor may be evaporated metal vapor, evaporated alloy vapor, a gas, a single-phase liquid, a multi-phase liquid, a melt, a sol, a solution, fluid mixtures, or combinations thereof. The metal-containing precursor, in some embodiments, comprises a stoichiometric or a non-stoichiometric metal composition with at least some part in a fluid phase. Fluid precursors are used in certain embodiments of this invention. Typically, fluids are easier to convey, evaporate, and thermally process, and the resulting product is generally more uniform. Solid precursors may be used as well.

In one embodiment of this invention, the precursors are environmentally benign, safe, readily available, high-metal loading, and lower cost materials. Examples of silver metal-containing precursors suitable for purposes of this invention include, but are not limited to, metal acetates, metal carboxylates, metal ethanoates, metal alkoxides, metal octoates, metal chelates, metallo-organic compounds, metal halides, metal azides, metal nitrates, metal oxides, metal sulfates, metal hydroxides, metal salts soluble in organics or water, and metal-containing emulsions.

In certain embodiments, precursors comprising silver nitrate, silver carbonate, silver oxide, and silver acetate are used.

In another embodiment, multiple metal precursors may be mixed if complex nanoscale and submicron powders are desired. For example, a silver precursor and a silicon precursor may be mixed to prepare silver silicate powders for thermal light switching applications. As another example, a palladium precursor, nickel precursor, and silver precursor may be mixed in correct proportions to yield a high purity powder for passive electronic component applications. In yet another example, a zinc precursor, copper precursor, and/or silver precursor may be mixed to yield doped silver powders for anti-microbial applications. Such complex nanoscale and submicron powders can create materials with surprising and unusual properties not available through the respective single metal-based compositions or a simple nanocomposite formed by physical blending powders of different compositions.

In another embodiment, one or more solvents are added to the metal comprising precursor in order to modify the thermal and flow properties of the precursor or to change the particle characteristics.

In all embodiments of this invention, it is desirable to use precursors of a higher purity to produce a nanoscale or submicron powder of a desired purity. For example, if purities greater than x % (by metal weight basis) are desired, one or more precursors that are mixed and used should have purities greater than or equal to x % (by metal weight basis) to practice the teachings herein.

With continued reference to FIG. 1, the metal-containing precursor 100 (containing one or a mixture of metal-containing precursors) is fed in some embodiments into a high temperature process 106 implemented using a high temperature reactor, for example. In one embodiment, a synthetic aid such as a reactive fluid 108 may be added along with the precursor 100 as it is being fed into the reactor 106. Examples of such reactive fluids include, but are not limited to, oxygen gas and air.

While the above examples specifically teach methods of preparing nanoscale and submicron powders of oxides, the teachings may be readily extended in an analogous manner to other compositions such as carbides, nitrides, borides, carbonitrides, and chalcogenides. While certain embodiments use high temperature processing, a moderate temperature processing or a low/cryogenic temperature processing may also be employed to produce nanoscale and submicron powders.

The precursor 100 may also be pre-processed in a number of other ways before the high temperature thermal treatment. For example, the pH may be adjusted to promote precursor stability. Alternatively, selective solution chemistry, such as precipitation, may be employed to form a sol or other state of matter. The precursor 100 may be pre-heated or partially combusted before the thermal treatment.

The precursor 100 may be injected axially, radially, tangentially, or at any other angle into the high temperature region 106. As stated above, the precursor 100 may be pre-mixed or diffusionally mixed with other reactants. The precursor 100 may be fed into the thermal processing reactor by a laminar, parabolic, turbulent, pulsating, sheared, or cyclonic flow pattern, or by any other flow pattern. In addition, one or more metal-containing precursors 100 may be injected from one or more ports into the reactor 106. The feed spray system may yield a feed pattern that envelops the heat source or, alternatively, the heat sources may envelop the feed, or alternatively, various combinations of this may be employed. In one embodiment, the feed is atomized and sprayed in a manner that enhances heat transfer efficiency, mass transfer efficiency, momentum transfer efficiency, and reaction efficiency. In one embodiment, the feed may be sprayed with a gas wherein the gas velocities is maintained between 0.05 mach to 50 mach and in certain embodiments between 0.25 to 2.5 mach. The reactor shape may be cylindrical, spherical, conical, or any other shape. Methods and equipment such as those taught in U.S. Pat. Nos. 5,788,738, 5,851,507, and 5,984,997, which are all hereby incorporated by reference in full, may be employed in practicing the method of this invention.

With continued reference to FIG. 1, after the precursor 100 has been fed into reactor 106, it is processed at high temperatures in some embodiments to form the product powder. In certain embodiment, the thermal treatment may be done in a gas environment with the aim to produce a product, such as powders, that have the desired porosity, density, morphology, dispersion, surface area, and composition. This step may produce by-products such as gases. To reduce costs, these gases may be recycled, mass/heat integrated, or used to prepare a pure gas stream used by the process.

In one embodiment, the high temperature processing is conducted at step 106 at temperatures greater than 1500 K, in certain embodiments greater than 2500 K, in certain embodiments greater than 3000 K, and in certain embodiments greater than 4000 K. Such temperatures may be achieved by various methods including, but not limited to, plasma processes, combustion, pyrolysis, electrical arcing in an appropriate reactor, and combinations thereof. The plasma may provide reaction gases or just provide a clean source of heat.

In the above embodiments, vapors of elements other than silver may be added to the silver comprising vapor to prepare complex compositions.

With continued reference to FIG. 1, the high temperature process 106 results in a vapor comprising the elements in the precursor. After the thermal processing, this vapor is cooled at step 110 to nucleate submicron powders, in certain embodiments nanopowders. In certain embodiments, the cooling temperature at step 110 is high enough to prevent moisture condensation. In certain embodiments, the nucleation step is conducted at high velocities, in certain embodiments above 0.25 mach, and in certain embodiments above 1 mach. The particles form because of the thermokinetic conditions in the process. By engineering the process conditions such as pressure, residence time, supersaturation and nucleation rates, gas velocity, flow rates, species concentrations, diluent addition, degree of mixing, momentum transfer, mass transfer, and heat transfer, the morphology of the nanoscale and submicron powders may be tailored. It is important to note that the focus of the process should be on producing a powder product that excels in satisfying the end application requirement and customer needs.

In certain embodiments, the nano-dispersed powder is quenched after cooling to lower temperatures at step 116 to minimize, and in certain embodiments prevent, agglomeration or grain growth. Suitable quenching methods include, but are not limited to, methods taught in U.S. Pat. No. 5,788,738. which is hereby incorporated be reference in full. Sonic to supersonic quenching is used in certain embodiments. In certain embodiments, quenching methods may be employed which can prevent deposition of the powders on the conveying walls. These methods may include, but are not limited to, electrostatic means, blanketing with gases, the use of higher flow rates, pneumatic means, mechanical means, chemical means, electrochemical means, or sonication/vibration of the walls.

In one embodiment, the high temperature processing system includes instrumentation and software that may assist in the quality control of the process. Furthermore, in certain embodiments, the high temperature processing zone 106 is operated to produce fine powders 120, in certain embodiments submicron powders, and in certain embodiments nanopowders. The gaseous products from the process may be monitored for composition, temperature, and other variables to promote quality at 112. The gaseous products may be recycled to be used in process 108, or used as a valuable raw material when nanoscale and submicron powders 120 have been formed, or they may be treated to remove environmental pollutants if any. Following the quenching step 116, the nanoscale and submicron powders may be cooled further at step 118 and then harvested at step 120.

The product nanoscale and submicron powders 120 may be collected by any method. Suitable collection means include, but are not limited to, bag filtration, electrostatic separation, membrane filtration, cyclones, impact filtration, centrifugation, hydrocyclones, thermophoresis, magnetic separation, and combinations thereof. In certain embodiments, a cake of the nanopowder may be formed on the collection media, which then acts as an efficient collector capable of collecting with efficiencies greater than 95%, and in certain embodiments greater than 99%.

The quenching at step 116 may be modified to enable preparation of coatings. In this embodiment, a substrate may be provided (in batch or continuous mode) in the path of the quenching powder containing gas flow. By engineering the substrate temperature and the powder temperature, a coating comprising the submicron powders and nanoscale powders may be formed.

A coating, film, or component may also be prepared by dispersing the fine nanopowder and then applying various known methods, such as, but not limited to, electrophoretic deposition, magnetophorectic deposition, spin coating, dip coating, spraying, brushing, screen printing, ink-jet printing, toner printing, and sintering. The nanopowders may be thermally treated or reacted before such a step to enhance their electrical, optical, photonic, catalytic, thermal, magnetic, structural, electronic, emission, processing, or forming properties.

It should be noted that the intermediate or product at any stage may be used directly as feed precursor to produce nanoscale or fine powders by methods such as, but not limited to, those taught in commonly owned U.S. Pat. Nos. 5,788,738, 5,851,507, and 5,984,997, and co-pending U.S. patent application Ser. Nos. 09/638,977 and 60/310,967, which are all hereby incorporated by reference in full. For example, a sol may be blended with a fuel and then utilized as the feed precursor mixture for thermal processing above 2500 K to produce nanoscale simple or complex powders.

In summary, In one embodiment, a method for manufacturing powders comprising silver comprises (a) preparing a fluid precursor comprising at least 100 ppm by weight of silver metal; (b) spraying the precursor into a high temperature reactor with a gas wherein the gas velocity is maintained at velocities greater than 0.05 mach, and in certain embodiments greater than 0.25 mach; (c) processing the spray in a high temperature reactor operating at temperatures greater than 1500 K, in certain embodiments greater than 2500 K, in certain embodiments greater than 3000 K, and in certain embodiments greater than 4000 K; (d) wherein, in the high temperature reactor, the precursor converts into vapor comprising the silver element; (e) cooling the vapor to nucleate submicron or nanoscale powders at high velocities; (f) quenching the powders at gas velocities exceeding 0.1 Mach to prevent agglomeration and growth; and (g) separating the quenched powders from the gases.

In another embodiment, a method of manufacturing nanoscale powders comprising silver comprises (a) preparing a fluid precursor comprising two or more metals, at least one of which is silver, in concentration greater than 100 ppm by weight; (b) spraying the precursor into a high temperature reactor with a gas wherein the gas velocity is maintained at velocities greater than 0.05 mach, and in certain embodiments greater than 0.25 mach; (c) processing the said spray in a high temperature reactor operating at temperatures greater than 1500 K, in certain embodiments greater than 2500 K, in certain embodiments greater than 3000 K, and in certain embodiments greater than 4000 K; (d) wherein, in the high temperature reactor, the said precursor converts into vapor comprising the silver metal; (e) cooling the vapor to nucleate submicron or nanoscale powders; (f) quenching the powders at gas velocities exceeding 0.1 Mach to prevent agglomeration and growth; and (g) separating the quenched powders from the gases.

In another embodiment, a method for manufacturing coatings comprises (a) preparing a fluid precursor comprising one or more metals, one of which is silver; (b) feeding the said precursor into a high temperature reactor operating at temperatures greater than 1500 K, in certain embodiments greater than 2500 K, in certain embodiments greater than 3000 K, and in certain embodiments greater than 4000 K; (c) wherein, in the high temperature reactor, the precursor converts into vapor comprising the silver wherein the vapor velocity is maintained at velocities greater than 0.05 mach, and in certain embodiments greater than 0.25 mach; (d) cooling and quenching the vapor to nucleate submicron or nanoscale powders onto a substrate to form a coating on the substrate comprising the silver powders.

Coated Powders

In another embodiment, core particles of any composition may be first prepared by any method, such as the methods taught herein. Next, silver comprising composition may be coated in nanostructured form on the core nanoparticles. This coating may be continuous, partial, or dispersed form as taught in U.S. patent application Ser. No. 10/004,387, which is hereby incorporated be reference in full.

To illustrate but not limit, zinc oxide submicron or nanoparticles are prepared by one of the methods taught in U.S. Pat. Nos. 5,788,738, 5,851,507, or 5,984,997, and co-pending U.S. patent application Ser. Nos. 09/638,977 and 60/310,967, which are hereby incorporated by reference in full. Next, in certain embodiments the zinc oxide nanoparticles (core particles) are dispersed in water to achieve a pH ranging from 1 to 12 and a conductivity ranging from 5 to 10,000 microsiemens/cm, in certain embodiments without any dispersants. Next, silver nitrate is added to the dispersion in darkness to prevent light driven reactions. A reducing or complexing agent may next be added to form silver on the zinc oxide particles. In certain embodiments, the silver forms a stable coating on the particles, and for this reason, the coated powders may be filtered or centrifuged. The powders may then be thermal processed to stabilize the coat. In one embodiment, the core particles is less than 1000 nanometers, in certain embodiments less than 100 nm, and in certain embodiments less than 40 nm; the coating comprising silver may be less than 20 nm thick, in certain embodiments less than 10 nm thick, and in certain embodiments less than 2.5 nm thick. A coated particles produced in this manner may retain silver in a form that allows the silver to be released in water in ionic form. This process yields commercially useful silver coated particles.

In some embodiments, copper oxide submicron or nanoparticles may be prepared by one of the methods taught in U.S. Pat. Nos. 5,788,738, 5,851,507, and 5,984,997, and co-pending U.S. patent application Ser. Nos. 09/638,977 and 60/310,967, which are all hereby incorporated by reference in full. The copper oxide nanoparticles (core particles) may be dispersed in water to achieve a pH ranging from 1 to 12 and a conductivity ranging from 5 to 10,000 microsiemens/cm, in certain embodiments without any dispersants. Next, silver nitrate may be added to the dispersion in darkness to prevent light driven reactions. A reducing or complexing agent may next be added to form silver on the copper oxide particles. In certain embodiments the silver forms a stable coating on the particles, and for this reason, the coated powders may be filtered or centrifuged. The powders may then be thermal processed to stabilize the coat. In one embodiment, the core particles may be less than 1000 nanometers, in certain embodiments less than 100 nm, in certain embodiments less than 40 nm; the coating comprising silver may be less than 20 nm thick, in certain embodiments less than 10 nm thick, and in certain embodiments less than 2.5 nm thick. Coated particles produced in this manner retain silver in a form that allows silver to be released in water in ionic form.

In another embodiment, copper zinc oxide submicron or nanoparticles are prepared by one of the methods taught in U.S. Pat. Nos. 5,788,738, 5,851,507, and 5,984,997, and co-pending U.S. patent application Ser. Nos. 09/638,977 and 60/310,967. The copper zinc oxide submicron (core particles) are dispersed in water to achieve a pH ranging from 1 to 12 and a conductivity ranging from 25 to 10,000 microsiemens/cm, in certain embodiments without any dispersants. Next, silver nitrate may be added to the dispersion in darkness to prevent light driven reactions. A reducing or complexing agent may next be added to form silver on the copper oxide particles. In certain embodiments the silver forms a stable coating on the particles, and for this reason, the coated powders may be filtered or centrifuged. The powders may then be thermal processed to stabilize the coat. In one embodiment, the core particles may be less than 1000 nanometers, in certain embodiments less than 100 nm, in certain embodiments less than 40 nm; the coating comprising silver may be less than 20 nm thick, in certain embodiments less than 10 nm thick, and in certain embodiments less than 2.5 nm thick. Coated particles produced in this manner retain silver, copper, and zinc in a form that allows them to be released in a biological environment in elemental, and in come embodiments, ionic form.

In yet another embodiment, tin oxide submicron or nanoparticles may be prepared by one of the methods taught in U.S. Pat. Nos. 5,788,738, 5,851,507, and 5,984,997, and co-pending U.S. patent application Ser. Nos. 09/638,977 and 60/310,967. The tin oxide submicron or nanoscale (core) particles are dispersed in water to achieve a pH ranging from 1 to 12 and a conductivity ranging from 25 to 10,000 microsiemens/cm, in certain embodiments without any dispersants. Tin oxide powder may also be dispersed in other solvents such as glycols, alcohols, hydrocarbons, or any other polar or non-polar solvent. Next, silver nitrate is added to the dispersion in darkness to prevent light driven reactions. The water or solvent is evaporated by adding heat to the solution at temperatures below the boiling point of solvent (assisted with vacuum in some embodiments). Removal of solvent causes the silver nitrate to loosely coat the core particles. The coated particles are then heated to temperatures ranging from 180 to 300° C. to melt and wet the silver nitrate on the core particles. The resulting powders are then heated to temperatures ranging from 380 to 500° C. to decompose silver nitrate to silver. Higher or lower temperatures may be used depending on the pressures and gas environment composition employed. In certain embodiments, the silver forms a stable coating (partial or full) on the particles and the coated powders may be filtered or centrifuged and then thermally processed to further stabilize the coat. In some embodiments, the core particles are less than 1000 nanometers, in certain embodiments less than 100 nm, and in certain embodiments less than 40 nm; the silver comprising coating may be less than 20 nm thick, in certain embodiments less than 10 nm thick, and in certain embodiments less than 2.5 nm thick. Coated particles produced in this manner retain silver, copper, and zinc in a form that allows them to be released in a biological environment in elemental, and in come embodiments, ionic form.

In one embodiment, a method to prepare silver coated oxide submicron or nanoparticles may be generalized to other compositions of matter as follows—(a) prepare nanoparticles of any composition; (b) mix the nanoparticles with nitrate (or any other compound such as carbonate, halide, hydroxide) of any element with or without solvents that disperse nanoparticles and/or dissolve the nitrate; (c) evaporate any solvents at or near the boiling point of the solvents; (d) ramp the temperature profile of the resultant product to temperatures where the nitrate melts and then decomposes or directly decomposes to yield a coated powder. Higher or lower temperatures may be used depending on the pressures and gas environment composition employed. The coated powders may be further thermal processed to stabilize the coat. In one embodiment, the method produces particles where the core particles are less than 1000 nanometers, in certain embodiments less than 100 nm, and in certain embodiments less than 40 nm. The coating thickness may be varied by changing the ratio of nanoparticle and nitrate.

The powders produced by teachings herein may be modified by post-processing as taught by commonly owned U.S. patent application Ser. No. 10/113,315, which is hereby incorporated by reference in full.

Methods for Incorporating Nanoparticles into Products

The submicron and nanoscale powders taught herein may be incorporated into a composite structure by any method. Some non-limiting methods are taught in commonly owned U.S. Pat. No. 6,228,904, which is hereby incorporated by reference in full.

The submicron and nanoscale powders taught herein may be incorporated into plastics by any method. In one embodiment, a method of incorporating submicron and nanoscale powders with plastics comprises (a) preparing nanoscale or submicron powders comprising silver by any method, such as the methods taught herein; (b) providing powders of one or more plastics; (c) mixing the nanoscale or submicron powders with the powders of plastics; (d) co-extruding the mixed powders into a desired shape at temperatures greater than the softening temperature of the powders of plastics but less than the degradation temperature of the powders of plastics. In another embodiment, a master batch of the plastic powder comprising silver metal containing nanoscale or submicron powders are prepared. These master batches may later be processed into useful products by techniques well known to those skilled in the art. In yet another embodiment, the silver metal containing nanoscale or submicron powders are pretreated to coat the powder surface for ease in dispersability and to ensure homogeneity. In a further embodiment, injection molding of the mixed powders comprising nanoscale powders and plastic powders may be employed to prepare useful products.

In another embodiment, a method for incorporating nanoscale or submicron powders into plastics comprises (a) preparing nanoscale or submicron powders comprising silver by any method, such as the methods taught herein; (b) providing a film of one or more plastics, wherein the film may be laminated, extruded, blown, cast, or molded; and (c) coating the nanoscale or submicron powders on the film of plastic by techniques including, but not limited to, spin coating, dip coating, spray coating, ion beam coating, sputtering. In another embodiment, a nanostructured coating is formed directly on the film by techniques such as those taught herein. In certain embodiments, the grain size of the coating may be less than 200 nm, in certain embodiments less than 75 nm, and in certain embodiments less than 25 nm. In certain embodiments, the nanoparticles may be applied on the surface of a plastic.

The submicron and nanoscale powders taught herein may be incorporated into or on glass by any method. In one embodiment, nanoparticles of silver may be incorporated into glass by (a) preparing nanoscale or submicron powders comprising silver by any method, such as the methods taught herein; (b) providing glass powder or melt; (c) mixing the nanoscale or submicron powders with the glass powder or melt; and (d) processing the glass comprising nanoparticles into articles of desired shape and size. In certain embodiments, the nanoparticles may be applied on the surface of a plastic.

Like plastics and glass, submicron and nanoscale powders taught herein may be incorporated into ceramic articles, flooring materials, kitchen articles, food wraps, napkins, cleaning sheets, food containers, cutting knives, eggs and meat processing and handling equipment, cooking utensils, dish washers, laundry equipment, ceramic or non-ceramic tiles, sanitary wares, wash sinks, door knobs, faucets, public facilities, day care products, baby toys, baby feeders, critical and emergency care equipment, hospital products, etc.

The submicron and nanoscale powders taught herein may be incorporated into paper by any method. In one embodiment, a method of incorporating submicron and nanoscale powders with paper comprises (a) preparing nanoscale or submicron powders comprising silver metals; (b) providing paper pulp; (c) mixing the nanoscale or submicron powders with the paper pulp; and (d) processing the mixed powders into paper by steps such as molding, couching, and calendering. In yet another embodiment, the silver metal containing nanoscale or submicron powders are pretreated to coat the powder surface for ease in dispersability and to ensure homogeneity. In a further embodiment, nanoparticles are applied directly on the manufactured paper or paper-based product; the small size of nanoparticles enables them to permeate through the paper fabric and thereby functionalize the paper. In the alternative, the nanoparticles may bind or adhere to the surface of the paper without substantially permeating the paper.

The submicron and nanoscale powders taught herein may be incorporated into leather, fibers, or fabric by any method. In one embodiment, a method for incorporating submicron and nanoscale powders with leather, fibers, or fabric comprises (a) preparing nanoscale or submicron powders comprising silver by any method, such as the method taught herein; (b) providing leather, fibers, or fabric; (c) bonding the nanoscale or submicron powders with the leather, fibers, or fabric; (d) processing the bonded leather, fibers, or fabric into a product. In yet another embodiment, the silver metal containing nanoscale or submicron powders are pretreated to coat the powder surface for ease in bonding or dispersability or to promote homogeneity. In a further embodiment, nanoparticles are applied directly on a manufactured product based on leather or fibers or fabric; the small size of nanoparticles enables them to permeate through the leather, fibers (polymer, wool, cotton, flax, animal-derived, agri-derived), or fabric and thereby functionalize the leather or fibers or fabric. In the alternative, the nanoparticles may bind or adhere to the surface of the leather, fibers, or fabric without substantially permeating the paper.

The submicron and nanoscale powders taught herein may be incorporated into creams or inks by any method. In one embodiment, a method of incorporating submicron and nanoscale powders into creams or inks comprises (a) preparing nanoscale or submicron powders comprising silver by any method, such as the method taught herein; (b) providing a formulation of cream or ink; and (c) mixing the nanoscale or submicron powders with the cream or ink. In yet another embodiment, the silver metal containing nanoscale or submicron powders are pretreated to coat the powder surface for ease in dispersability and to promote homogeneity. In a further embodiment, pre-existing formulation of a cream or ink is mixed with nanoscale or submicron powders to functionalize the cream or ink.

Nanoparticles comprising silver may sometimes be difficult to disperse in water, solvents, plastics, rubber, glass, paper, etc. In one embodiment, the dispersability of the nanoparticles is enhanced by treating the surface of the silver powders or other silver comprising nanoparticles. For example, fatty acids (e.g. propionic acid, stearic acid and oils) is applied to or with the nanoparticles to enhance the surface compatibility. If the silver comprising complex composition powder has acidic surface, ammonia, quaternary salts, or ammonium salts may be applied to the surface to achieve desired surface pH. In other cases, acetic acid wash may be used to achieve the target surface state. Trialkyl phosphates and phosphoric acid may be additionally applied in some applications to reduce dusting and chemical activity.

Applications of Nanoparticles and Submicron Powders Comprising Silver Elements

Structural Coatings

Silver comprising nanoparticles when coated onto metal bearings, such as steel bearings, may offer greater fatigue strength and load carrying capacity. This can be particularly useful in hi-tech and heavy-duty applications. More specifically, nanomaterials of silver offer a unique combination fatigue resistance, corrosion resistance, lubricity, and thermal conductivity.

Nanoparticles comprising silver may be useful whenever nanocomposite with fatigue resistance, corrosion resistance, lubricity, and thermal conductivity are desired.

Energy devices, Batteries and Fuel Cells

Nanoparticles comprising silver offer several unusual benefits to energy applications. These benefits may be a consequence of (a) the small size of nanoparticles which can enable very thin film devices, (b) high surface area which can simplify the manufacturing processes, and (c) unusual grain boundary effects. These properties may be used to prepare electroceramic devices such as capacitors, piezoelectric devices, batteries, and electrodes for devices, such as fuel cells and sensors.

Many batteries, both rechargeable and disposable, are already manufactured with silver alloys as the cathode. Although expensive, silver cells have superior power-to-weight characteristics. In certain embodiments, the form of these batteries may be the small button shaped silver oxide cell (about 35% silver by weight). The silver battery provides higher voltages and long life required for high reliability products, such as watches, cameras, small electronic devices, and larger batteries for tools and portable TV cameras.

Nanoparticles comprising silver offer several benefits to battery applications. These benefits are a consequence of factors such as (a) the small size of nanoparticles which can enable very thin film devices, (b) high surface area which can lower the forming temperatures and forming times, (c) unusual grain boundary effects and large grain boundary contributions, and (d) higher surface area for superior electrochemical kinetics. For these applications, nanoparticulate silver oxides comprising suitable dopants may be particularly useful. In certain embodiments, for battery applications, the nanoparticles comprising silver may have a surface area greater than 1 m²/gm, in certain embodiments greater than 5 m²/gm, and in certain embodiments greater than 15 m²/gm.

Electrical Applications

Silver is an excellent electrical conductor. Nanoparticles comprising silver in certain embodiments offer superior conducting layers and interconnects in nanodevices and microprocessors. This is in part because silver nanomaterials combine an unusually low affinity for oxygen, ability to form thinner coatings for lower costs per unit function, and high electrical conductivity. This opens up many applications. For example, electric motor control switches employing such silver comprising nanomaterials are useful in washing machines, dryers, automobile accessories, vacuum cleaners, electric drills, elevators, escalators, machine tools, locomotives, diesel engines, etc.

The circuit breaker is another application of silver nanoparticles. In these applications, silver combines the highest thermal conductivity and the highest electrical conductivity. In nanoparticle form, silver may reduce the coating thickness and loading required per unit performance. In certain embodiments, coated submicron and nanoscale powders (e.g. silver coated on tin oxide or cadmium oxide with or without other nanoscale additives) are particularly useful for these applications, because they offer long life time, low contact resistance, high reliability against contact welding, and good arc mobility and arc extinguishing properties.

Other applications where electrical properties of silver nanoparticles may be useful include, but are not limited to, membrane switch panels on microwaves, dish washers, ovens, security key boards, entertainment products, computers, keyboards, instrumentation, windshields, and screen printed circuits.

Catalysts

Silver comprising substances are well established in the commercial catalysis industry. However, the surface area and surface characteristics achievable, particularly in doped forms of silver comprising nanoparticles, with current technologies are limited. Nanoparticles taught herein offer means to make it possible to overcome these limitations.

In one embodiment, a method for manufacturing catalysts comprises (a) preparing a fluid precursor comprising one or more elements, one of which is silver; (b) feeding the precursor into a high temperature reactor operating at temperatures greater than 1500 K, in certain embodiments greater than 2500 K, in certain embodiments greater than 3000 K, and in certain embodiments greater than 4000 K; (c) wherein, in the high temperature reactor, the precursor is converted into a vapor comprising silver wherein the vapor velocity may be maintained at velocities greater than 0.05 mach, and in certain embodiments greater than 0.25 mach; (d) the vapor may be cooled and quenched to nucleate submicron or nanoscale powders comprising silver; (e) the submicron or nanoscale powders comprising silver may be used as a wash coat on catalyst substrates or as catalysts or both.

The unique interaction between silver and oxygen in nanoparticle form can be particularly useful to catalytic applications. For example, the production of formaldehyde and ethylene oxide can benefit from the use of silver comprising nanoscale catalysts. Such products are particularly desired for the production of surface coatings including paints, dinnerware and buttons, appliance casings, handles and knobs, packaging materials, automotive parts, adhesives, toys, powder coatings, resins, finishes for paper and textiles, laminating resins for construction plywood and particle board, Mylar recording tape for audio, VCR, and other types of recording tapes, molded items, thermal and electrical insulating materials, cleaning fluids, antifreeze for automobiles and other types of vehicles.

Silver nanoparticles offer a weak interaction with oxygen. Silver dissociates molecular oxygen from the air and weakly holds onto the separated oxygen atoms until an alkene such as ethylene reacts with it to form respective alkene oxide.

Silver comprising nanoparticles prepared using the teachings herein offer the potential to reach a number of surprising and unique advantages.

The catalyst powders described herein may be combined with zeolites and other well defined porous materials to enhance the selectivity and yields of useful chemical reactions.

Biomedical Applications and Dental Materials

Nanoparticles comprising silver offer several benefits in biomedical applications. Nanoscale silver in undoped form and doped forms are useful in anti-microbials. In certain embodiments, dopants added to silver include, but are not limited to, zinc, copper, or a micronutrient. In certain embodiments, the particle size is below 40 nanometers and metal purity greater than 99.9% by metal weight.

Silver is already employed as a bactericide and algaecide in water purification systems in hospitals, remote communities and, increasingly in domestic households. Silver ions have been used to purify drinking water and swimming pool water for generations. The anti-microbial performance of silver has been known for centuries. The catalytic action of silver in combination with its special interaction with oxygen explained above, provides a powerful broadband anti-microbial reducing, or ins some embodiments, virtually eliminating, the need for the use of corrosive chlorine.

Nanomaterials comprising silver metal are particularly useful because for several reasons some of which include (a) in nanomaterial form, silver is very effectively applied and available given its high surface area; this offers an anti-microbial action that is at least 10% faster than anti-microbial action achievable with 1 micron particles of silver; (b) silver availability is greater in nanoparticulate form requiring the use of less silver to achieve the same effects obtained using traditional silver forms; this is highly desirable because silver is a relatively expensive metal; (c) the domain confinement effects enhance the performance and availability of silver (see the motivations outlined elsewhere in this invention); (d) the small size of nanoparticles comprising silver may allow them to reach very fine pores where bacteria, algae, yeast and other microbes can grow profusely; (e) the small size enable nanomaterials comprising silver to be incorporated in numerous products per the teachings herein; (f) given their small size (below 100 nm and in certain embodiments below 40 nm), nanoparticles comprising silver may be made substantially translucent or transparent to visible light with wavelengths between 400-700 nm; (g) in nanoparticle form, silver works by blocking oxygen delivery necessary for the microbes/bacteria membrane metabolic pathways based on peptidoglycans; this makes silver effective against all bacteria and microbes that have peptoglycans or similar composition of matter. This, in numerous embodiments, prevents bacteria's ability to become resistant to this unusual nanotechnology-enabled anti-microbial. Since mammalian cells lack a peptidoglycan cell coating, silver has no effect upon those cells. Silver nanoparticles are thus safe to mammalian cells, while destructive to microbes and other organisms with peptidoglycans or similar composition of matter.

Additionally, any cell that does not possess a chemically resistant wall may also be inactivated by silver and silver comprising nanoparticles. This makes silver nanotechnology useful in wide range of disease prevention.

The surprisingly high availability of ultra-fine grain size of nanostructured materials results from the small nanoscale size giving an excess Gibbs free energy to the system compared to the conventional large grained (micrometer size) materials. This will significantly enhance the solubility because:

$$\frac{{C}_{d}}{{C}_{∞}} = \frac{k V}{RT} \frac{σ}{d}$$

where:
C_{d} and C_{∞}=solubilities of a solute in the material with average grain size d and infinite grain size, respectively;
R=gas constant;
T=temperature;
V=the molar volume of the solute;
k=Boltzmann's constant; and
σ=the surface energy of the grain.

Thus, a 10 nm particle offers a solubility 1000 times higher than a 10 μm particle with the same chemical composition.

In addition, the large volume fraction of interface in nanostructured materials will result in grain boundary diffusion dominating the overall diffusion in the materials. The overall or effective diffusivity of solute atoms in the material is given by:
D^{eff}=fD_{gb}+(1−f)Dₗₜ
where:
D^{eff}=the effective or overall diffusion coefficient;
D_{gb}=the diffusion coefficient in grain boundaries;
Dₗₜ=the diffusion coefficient within grains; and
f=the fraction of solute atoms on the grain boundaries.

Since D_{gb} normally is 10⁴ times higher than Dₗₜ, or in other words D_{gb}>>Dₗₜ, and more than 30% of atoms are situated in the grain boundaries, the above equation can be rewritten as
D^{eff}≈fD_{gb}=0.3D_{gb}<<Dₗₜ

The solute diffusion coefficient in nanostructured materials, therefore, is expected to be 1000 to 10,000 times higher than in conventional micro-grained materials.

The surprisingly high availability of nanoscale materials in general, and particularly silver comprising nanoscale materials, may be guided by the insight that the high surface area of the nanoscale particles accelerate those physiological processes that depend on the surface area of the particles. It is important to note that the change in free energy of a particle is composed of change in volume-related free energy and the change in surface-related free energy. The volume related free energy is a result of the energy release as bonds form between atoms that constitute the particle. The surface related free energy is a result of the energy change when surface atoms dissolve into the liquid or medium, or they solvate by forming free energy reducing bonds with the liquid or medium. As nanoparticles are confined to smaller and smaller sizes, the surface tension-related energy becomes more and more significant part of total thermodynamic free energy for the substance. At a critical nanoparticle size, called the nano-solvation diameter, the change in free energy with changing size becomes zero. Thereafter, further reduction in particle size are thermodynamically favored and the nanoparticle begins to dissolve into the medium. For actives, drug, and antimicrobial delivery, this is the regime one must strive for and the nanotechnology taught herein enables one to do that. More specifically, this nano-solvation diameter can be given by:
δₚ=ΔG_{S}/3*ΔGᵥ
where:
   δₚ=critical nano-solvation diameter (nanoparticle size); (meters)
   ΔGₛ=surface tension (J/m²)
   ΔGᵥ=free energy gain through bond formation per unit volume (J/m³);

In certain embodiments, nano-solvation diameter may be calculated and the particles engineered to a size below the nano-solvation diameter. Surface tension and free energy data for silver and/or other elements may be determined by any technique including those that are already known in the art. Literature values may be used to calculate the nano-solvation diameter. In the absence of such calculation, the nano-salvation diameter may be estimated as (i.e. domain size of the particle be less than) 125 nanometers, in certain embodiments less than 85 nanometers, in certain embodiments less than 40 nanometers, and in certain embodiments less than 10 nanometers. If time release characteristics are sought, it is equally important that the particle size not be too small as the dissolution rate is faster with smaller and smaller particles. For time release applications, in certain embodiments, the particle sizes may be engineered such that they have particle size distribution as follows—D₂₅>0.25*δₚ and D₇₅<δₚ; in certain embodiments they may have particle size distribution as follows—D₀₁>0.25*δₚ and D₉₉<δₚ. In certain embodiments, the surface of the nanoparticles may be clean. In certain embodiments, nanoscale powders that are less agglomerated may be preferred over those that are agglomerated. Atomic disorder and crystalline defects that increase the interfacial area of nanoparticles, but do not increase the “available surface area” of nanoparticles are not preferred for teachings in this application. Nanoparticles wherein at least 25% by weight, in certain embodiments at least 50% by weight, in certain embodiments at least 75% by weight, and in certain embodiments at least 90% by weight of the nanoparticles are substantially free of atomic disorder may be used in this invention. The term “available surface area” means that surface area of particle that is available for interaction with media or another substance. The available surface area of nanoparticles may be measured, as first approximation, to be the BET surface area using instruments manufactured by companies such as Coulter®, Micromeritics® and Quantachrome®. While these teachings may be employed to all substances that need to be solubilized in a fluid or solvent or medium, these teachings are even more valuable when the inherent solubility of an organic or inorganic active, medicine, drug, pharmaceutical, nutrient is low to very low in the desired medium. Nanotechnology products comprising silver prepared using the teachings herein may be used to provide effective and broadband microbial protection. Furthermore, this may reduce the cost of care.

These insights suggest that silver's effectiveness by both mechanisms (silver delivery and unusual oxygen activity) may be significantly enhanced by nanotechnology.

In some embodiments, silver comprising nanomaterials (as coated powder or as nanoparticles) may be combined with medicinal creams (such as paminobenzenesulfonamide, penicillin, sulfa drugs, etc.), medicinal powder, topical creams, band-aids, skin-growth promoting and wound-healing products, pastes, sprays, and any other delivery fluid to enhance or provide anti-bacterial action. The nanoscale size of silver nanomaterials may make formulation preparation easier and cost effective.

In certain embodiments, silver comprising nanomaterials (as coated powder or as nanoparticles) may be incorporated in air filters, water filters, or in adsorption or absorption or wash beds to provide anti-bacterial action. This may promote clean drinking water and prevent diseases and thereby reduce associated health care costs. Such filters, in certain embodiments, are also be extremely useful in biological terror-response kits where the nature of the pathogen is not known or where the pathogen may be a mutant of known naturally-occurring pathogens.

In certain embodiments, silver comprising nanomaterials (as coated powder or as nanoparticles) may be incorporated in plastics, ceramic, glass, paper, fabric, textile, wood, leather, and metallic products to provide anti-bacterial action. Illustrative methods for such incorporation are discussed herein. In addition, any methods known in the art may be employed to benefit from such beneficial properties of silver.

In some embodiments, the anti-microbial performance taught herein may be used in plastics, glass, ceramic articles, flooring materials, kitchen articles, food packaging, fruit packaging, milk product packaging, seafood packaging, egg product packaging, meat packaging, flower packaging, food wraps, napkins, cleaning sheets, food containers, cutting knives, eggs and meat processing and handling equipment, cooking utensils, dish washers, laundry equipment, ceramic or non-ceramic tiles, sanitary wares, wash sinks, door knobs, faucets, public facilities, day care products, baby toys, baby feeders, critical and emergency care equipment, immobile care products, hospital products, blood bags, blood and body fluid sampling products, etc.

When combined with copper, zinc, other elements, or combinations thereof, the effectiveness of silver may be further enhanced while cost reduced. In certain embodiments, the particle may be retained as nano-engineered particles.

Silver nanoparticles may also be incorporated in dental materials and fillings to reduce bacterial growth and cavities. These silver nanoparticles may be useful in new dental composites, such as those based on silicones and acrylates, entering commercial use.

It is worthy noting that silver should be used in appropriate concentrations to avoid overwhelming the physiological processes inside mammalian systems including human beings. In the case of silver, excessive amounts may eventually deposit in the skin, giving it a gray color. Such deposition may lead to a state called argyria. Similarly, silver like other elements and nutrients should be taken with care in individuals suffering from blood-brain barrier breakdown.

In one embodiment, a method for preparing anti-microbial nanoparticles comprises (a) preparing a fluid precursor comprising one or more elements, one of which is silver; (b) feeding the precursor into a high temperature reactor operating at temperatures greater than 1500 K, in certain embodiments greater than 2500 K, in certain embodiments greater than 3000 K, and in certain embodiments greater than 4000 K; (c) wherein, in the high temperature reactor, the precursor may be converted into a vapor comprising silver wherein the vapor velocity may be maintained at velocities greater than 0.05 mach, and in certain embodiments greater than 0.25 mach; (d) the vapor is cooled and quenched to nucleate submicron or nanoscale powders comprising silver; and (e) the submicron or nanoscale powders comprising silver may be used as antimicrobials. Alternatively, these may be used as additives for biomedical tubes, stents, implants, or devices for humans or animals.

Photochromaticity

In one embodiment of this invention, silver nanoparticles is incorporated in oxide films to prepare unusual multicolor photochromic products. Normal photochromatic materials are monochromatic. With silver comprising nanoparticles incorporated in thin films, such as that of titanium comprising oxide, tungsten comprising oxide, zirconium comprising oxide, rare earth comprising oxide, multimetal oxides, etc., films may be prepared that change color matching that of the incident light. This film may be regenerated reversibly with the use of ultraviolet. Such novel color effects may be useful to prepare designer sunglasses, adaptive fabric, security and authencity-identification products, and other products mentioned herein. In certain embodiments, such silver nanoparticle comprising thin films may be multifunctional—where they offer a combination of anti-microbial activity and color photochromaticity. When combined with titania, such silver comprising films may also be self-cleaning given the photocatalytic properties of titania. When combined with multilayer film structures known in the art (e.g. dielectric films, refractive index optimized films and/or conductive films), anti-reflective or anti-static properties may also be added to the combination of properties.

Consumer Applications

Nanoparticles comprising silver taught herein offer several benefits in consumer product and related applications. The unusual and cost effective anti-microbial properties may be used in any product that can benefit from anti-bacterial characteristics.

In one embodiment, silver comprising nanoparticles may be added in small concentrations (below 10% by weight, in certain embodiments below 1%, and in certain embodiments below 0.1%) to tooth paste and mouth rinse formulations to provide strong anti-microbial action. This may prevent dental problems such as gum diseases.

In one embodiment, silver comprising nanoparticles may be added in small concentrations (in certain embodiments below 10% by weight, in certain embodiments below 1%, and in certain embodiments below 0.1%) to eye drop dispensers to provide longer life and strong anti-microbial action.

In one embodiment, silver comprising nanoparticles may be added in small concentrations (in certain embodiments below 10% by weight, in certain embodiments below 1%, and in certain embodiments below 0.1%) into contact lenses polymers and to lens cleaning formulations to increases comfort and to provide strong anti-microbial action. Additionally, silver nanoparticles can also protect eyes during use by becoming dark in strong light and reversing back to transparency when light levels are low.

In one embodiment, silver comprising nanoparticles may be incorporated in small concentrations (below 10% by weight, in certain embodiments below 1%, and in certain embodiments below 0.1%) to antiperspirant and sanitary formulations to destroy microbes and bacteria.

In one embodiment, silver comprising nanoparticles may be incorporated in small concentrations (in certain embodiments below 10% by weight, in certain embodiments below 1%, and in certain embodiments below 0.1%) in toys, baby feeding products, baby cribs, and other baby-care and child-care products to destroy microbes and bacteria. Babies tend to put everything in their mouths and their saliva is a good breeding ground for microbes and bacteria. Children also tend to play with everything, and child care centers tend to be grounds where microbes can grow and be transmitted. Silver comprising nanoparticles, when incorporated into baby-care and child-care products by nanotechnology methods taught herein or by any other methods, can provide broad protection and prevention technology.

In one embodiment, silver comprising nanoparticles may be incorporated in small concentrations (in certain embodiments below 10% by weight, in certain embodiments below 1%, and in certain embodiments below 0.1%) to laundry detergents and dish washing formulations to destroy microbes and bacteria.

In one embodiment, silver comprising nanoparticles may be incorporated in small concentration (in certain embodiments below 10% by weight, in certain embodiments below 1%, and in certain embodiments below 0.1%) to fabric, leather products, and textiles, particularly sporting fabric, clothings, socks, slippers, underwear, self-care bandages, diapers, menstrual-care pads, etc. to destroy microbes and bacteria that grow, create smell and diseases, and slow the natural healing process.

In one embodiment, silver comprising nanoparticles may be incorporated in small concentration (in certain embodiments below 10% by weight, in certain embodiments below 1%, and in certain embodiments below 0.1%) to wound wipe pads, napkins, tissue paper, towels, etc. to destroy microbes and bacteria and any other cause or form of infection.

In one embodiment, silver comprising nanoparticles may be incorporated in small concentrations (below 10% by weight, in certain embodiments below 1%, and in certain embodiments below 0.1%) to face cream and other face, skin, or nail care formulations to destroy microbes, viruses, and bacteria that may be a source of pimples and facial skin imperfections.

In one embodiment, silver comprising nanoparticles may be incorporated in small concentrations (below 10%, in certain embodiments below 1%, and in certain embodiments below 0.1%) to automotive fabric, seats, door, and air filters to destroy microbes and bacteria. Similarly, these may be incorporated into air filters, dust filters, dehumifiers, humidifiers, drinking water filters, and delivery equipment in airplanes and airports given that these equipment are well known sources of bacterial growth.

Wood protection creams and fluids, glass cleaning and protection formulations, kitchen cleaners, sink cleaning fluids and sprays, general cleaning fluids, shower heads, special paints, etc. may be additional sources of microbial, mildew, algae, fungal, etc. growth. In one embodiment, silver comprising nanoparticles may be incorporated in small concentration (below 10%, in certain embodiments below 1%, and in certain embodiments below 0.1%) to destroy microbial action.

Currency notes by their very nature move between different people. These notes may be a source of microbial transfer between various unsuspecting individuals. In one embodiment, silver comprising nanoparticles are coated on currencies to destroy such microbes and thereby reduce the transmission of disease.

These embodiments are just a few examples where the anti-microbial action of silver comprising nanoparticles may be usefully employed. Existing equipment may be easily sprayed and coated to provide broad anti-microbial action. Modifications of these teachings may be readily performed by one of ordinary skill in the art to achieve the microbial protection sought.

Reagent and Raw Material for Synthesis

Nanoparticles of silver oxide and silver containing multi-metal oxide nanoparticles may be useful reagents and precursors to prepare other compositions of nanoparticles comprising silver. In a generic sense, nanoparticles comprising silver may be reacted with other compounds, such as, but not limited to, acids, alkalis, or solvents; the high surface area of nanoparticles may facilitate the reaction. The product resulting from this reaction may also be nanoparticles. These product nanoparticles may then be suitably applied or utilized to catalyze or as reagents to prepare other chemicals. A few non-limiting embodiments using silver or other nanoparticles follow. These teachings may be extended to multi-metal oxides and to other compositions, such as silver oxide, silver acetate, and organometallics based on silver.

Silver Nitrate: In some embodiments, silver nitrate nanoparticles may be synthesized by reacting silver comprising nanoparticles with nitric acid. Silver nitrate has a wide application in painting, xerography, chemical electroplating, in components for electric batteries, and in medicine as a catalyst. Silver chloride is another important compound, due to its ductility and malleability. The organic compounds of silver may be used in the coating of several metals and in dynamite or other explosives.

Silver Oxide: In some embodiments, silver oxide nanoparticles may be synthesized by reacting silver comprising nanoparticles with ozone and/or peroxides.

Surface treated silver comprising nanoparticles: In some embodiments, silver comprising nanoparticles or silver oxide nanoparticles may be surface reacted and functionalized by first dispersing the nanoparticles in a sovent, adding another species, such as an acid (sulfuric, nitric, hydrochloric, hydrobromic, acetic, formic, phosphoric etc.), a base (ammonia, sodium hydroxide, etc.), a surfactant or dispersant, or other such species to the said dispersion, and then post processing such a dispersion through a mixer or a drier or thermal treatment. Such nanoparticles are useful as catalysts and in the preparation of dispersions in certain embodiments. Nanoparticles comprising silver may be compounded with vanadium and other Group 5, 6, and 7 elements of the periodic table and with rare earth elements to prepare nanoparticles of silver compounds useful in batteries, electrical, optical, display, security, electrochemical, catalyst, and other applications.

### EXAMPLES 1-3

### Silver Powders

99.9+weight % by metal pure silver nitrate precursor was dissolved in water and isopropyl alcohol until the viscosity of the precursor was less than 100 cP. This mix was sprayed into a thermal plasma reactor described above at a rate of about 50 ml/min using about 80 standard liters per minute oxygen. The peak vapor temperature in the thermal plasma reactor, processed at velocities greater than 0.25 mach, was above 3000 K. The vapor was cooled and then quenched by Joule-Thompson expansion. The powders collected were analyzed using X-ray diffraction (Warren-Averbach analysis) for spectra, phase and peak broadening; and BET analyzer for surface area. It was discovered that the powders had a crystallite size of less than 50 nm and a specific surface area of greater than 1 m²/gm.

The precursor was diluted further with the alcohol and water mix and then the run repeated. It was discovered that the powders had a crystallite size of less than 30 nm and a specific surface area of greater than 1.5 m²/gm.

The run was repeated at a lower feed rate of 30 ml/min. It was discovered that the powders had a crystallite size of less than 25 nm and a specific surface area of greater than 2.5 m²/gm.

These examples show that nanoparticles comprising silver can be prepared and that the characteristics of silver powder can be varied with process variations. Inasmuch as one of the primary inventive concepts of the invention is silver comprising nanoparticles, it is clear that the concept contained in this example, other examples, and the description herein could be applied to a system where metals in addition to silver are present. Similarly, it is expected that specific changes in materials and procedures may be made by one skilled in the art to produce equivalent results.

### EXAMPLE 4

### Silver Nanoparticles

A hundred liter raw material batch was prepared by mixing 18.4 kgs of silver nitrate (>99.9% purity) into 48 kgs of demineralized water. Next, 40 kgs of isopropyl alcohol were added to the silver nitrate dissolved in the water. This yielded about 100 liters of silver comprising raw material. The silver comprising precursor mix was then combusted in 99%+pure oxygen in the presence of argon-based DC thermal plasma in a reactor operating between about 0.1-0.75 atmospheres. The maximum feed velocity and gas processing velocities were above 0.1 mach, and the peak processing temperatures were above 3200 K. The vapor was cooled to nucleate nanoparticles and then quenched using Joule Thompson effect as taught in co-owned U.S. Pat. No. 5,788,738. The powders were collected on a conductive polymer membrane filtration system. The collected powders were analyzed and were found to be pure silver and have a X-ray crystallite size less than 40 nanometers and a surface area greater than 2 m²/gm. The powder was examined under high resolution transmission electron microscope and was observed to be non-amorphous. It lacked atomic disorder. A thermogravimetric study indicated that the silver particles had undetectable weight loss suggesting that the surface was clean. This example illustrates that surface-clean silver nanoparticles can be successfully prepared.

This example offers some surprising contrast with traditional teachings, such as those taught by Burell et al. in U.S. Pat. No. 5,681,575. Burell et al. teach that it is necessary to use silver with sufficient atomic disorder for antimicrobial activity. They teach that atomic disorder and point defects should be engineered into crystals by techniques such as vacuum deposition, cold working, sputtering for antimicrobial activity. In contrast, we surprisingly find that silver nanoparticles without artificially induced point defects and atomic disorder can be effective antimicrobials if they have clean surfaces and maintain a domain size less than 100 nanometers. In more optimized systems, silver nanoparticles sizes may be further reduced to a size in certain embodiments less than 50 nanometers, in certain embodiments less than 25 nanometers, and in certain embodiments 10 nanometers. It is important to note that the concept of “artificially induced” atomic disorder is important, because making perfect crystals with absolutely no defects is kinetically difficult by “natural processes” and in a practical sense, thermodynamically prohibited. Nature favors an equilibrium level of thermodynamic defects in crystals for a given processing state. Burell et al. teach artificial point defects and atomic disorder over and beyond those that occur naturally in silver (and other metals) for antimicrobial performance. We teach a new class of anti-microbials wherein the beneficial properties of silver are obtained from non-agglomerated discrete nanomaterials comprising of silver or other elements synthesized with clean surfaces and that are substantially free of atomic disorder (i.e. without artificially created atomic disorder inside the domain of each nanoparticle over and beyond the naturally occurring defects in the lattice). This insight may be extended to other elements for applications taught herein, illustrative elements include—Cu, Zn, Au, Pt, Pd, Ir, Ru, V, Ca, K, Na, Sn, Sb, Bi, and rare earth elements or alloys, compounds, and composites containing one or more of these elements. In some embodiments, the elemental composition of the actives in the nanoparticle are greater than 95%, in certain embodiments greater than 99%, in certain embodiments greater than 99.9%, and in certain embodiments greater than 99.95%.

The silver nanoparticle produced above were dispersed in water to yield a grayish-black dispersion that was stable. This dispersion may be used as nano-ink.

Silver nanoparticles with high available surface area produced using this example and broader teachings herein are excellent broadband anti-microbials, anti-fungal, and anti-bacterial agents. They may be applied as coatings, additives, in creams, or as part of bandages to treat infected parts or wounds to prevent infection.

### EXAMPLE 5

### Silver Coated Silica Nanoparticles

About 16.3 grams of silica nanoparticle dispersion (12 nanometers) in isopropyl alcohol was mixed with about 10 grams of glycerol in a beaker. To this dispersion, about 10.5 grams of silver nitrate (>99.99% purity) was dissolved. The beaker was wrapped in aluminum foil to prevent light driven reactions. The dispersion was warmed to 75° C. to ensure that the nitrate was completely dissolved yielding a transparent dispersion with a light brown tint. The solution was then heat treated for 1 hour at 450° C. in open atmosphere. About 11.9 grams of fluffy powder was collected. The powder was analyzed with X-ray diffractometer and strong silver metal peaks were observed. The surface area using 5 point BET analysis was greater than 90 m²/gm. The powder was examined under a high resolution transmission electron microscope and was observed to be non-amorphous, and it lacked atomic disorder (Example-7 is the only SiO2/Ag powder that was sent for TEM). A thermogravimetric study indicated that the silver particles had undetectable weight loss suggesting that the surface was clean (did not perform TGA on this sample). This example illustrates that silver coated ceramic nanoparticles can be prepared. The electrical conductivity of coated powders was measured and they were found to be non-conductive. This suggests that the coating was non-uniform.

### EXAMPLE 6

### Silver Coated Silica Nanoparticles

About 32.7 grams of silica nanoparticle dispersion (12 nanometers) in isopropyl alcohol was mixed with about 50 grams of IPA in a beaker. To this dispersion, about 3 grams of silver nitrate (>99.99% purity) was dissolved. The beaker was wrapped in aluminum foil to prevent light driven reactions. The dispersion was warmed to 75 C to evaporate the alcohol. This yielded a clean white powder, which was then heat treated at 500° C. to give over 10 grams of powder. The powder was analyzed with X-ray diffractometer and strong silver metal peaks were observed. This example again illustrates that silver coated ceramic nanoparticles can be prepared. The electrical conductivity of coated ceramic powders was measured and they were found to be non-conductive. This suggests that the coating was patchy and non-uniform.

### EXAMPLE 7

### Silver Coated Silica Nanoparticles

In this experiment, about 16.3 grams of silica nanoparticle dispersion (12 nanometers) in isopropyl alcohol was mixed with about 21.6 grams of glycerol in a beaker. To this dispersion, about 21.1 grams of silver nitrate (>99.99% purity) was dissolved. The beaker was wrapped in aluminum foil to prevent light driven reactions. The viscous dispersion was warmed to ensure that the nitrate was completely dissolved. The solution was then heat treated for 2.5 hours at 500° C. and then for 2.5 hours at 800° C. in open atmosphere. The powder was examined under a high resolution transmission electron microscope and was observed to be sub-100 nanometers in size, non-amorphous and lacking atomic disorder. The electrical conductivity of coated powders was measured, and they were found to have a conductivity within an order of magnitude of pure coarser (greater than 1 micron sized) silver powder. This suggests that conductive nanoparticles for electrode and ink applications can now be prepared. This example illustrates that conductive silver coated ceramic nanoparticles can be prepared.

### EXAMPLE 8-9

### Silver Coated Tin Oxide Nanoparticles

Tin oxide nanopowders were prepared using the process described herein and the cited commonly owned patents. These are commercially available from NanoProducts Corporation as PureNano™ tin oxide nanoparticles. About 2.9 grams of tin oxide nanoparticles were dispersed in 9.5 grams of de-ionized water and 7.1 grams of silver nitrate (>99.9% purity). No glycerol was added. The powder was heat treated for 1 hour at 450° C. in open atmosphere. The powder was analyzed with X-ray diffractometer and strong silver metal peaks were observed. The surface area using 5 point BET analysis was greater than 5 m²/gm (Do not have SSA data for this sample). The powder was examined under a high resolution transmission electron microscope and was observed to be sub-80 nanometers, non-amorphous, and it lacked atomic disorder. This example illustrates that silver coated tin oxide nanoparticles can be prepared. The electrical conductivity of coated powders was measured, and they were found to be very conductive. This suggests that the conductive silver coated nanoparticles can be prepared.

In another experiment, we heat treated the tin oxide nanoscale powders to temperatures above 500 C in ambient air, cooled the powders to about 220 C and then added silver nitrate. The silver nitrate melted and coated the powders thereby producing silver comprising nanoparticles. These coated powders were heated to about 450 C which caused the silver nitrate to convert to silver metal coating. Further heating caused sintering to occur resulting in a nanostructured sintered mass.

### EXAMPLE 10

### Silver Comprising Zinc Oxide Nanoparticles

Zinc oxide nanopowders were prepared using the process described herein and the cited commonly owned patents. These are commercially available from NanoProducts Corporation as PureNano™ zinc oxide nanoparticles. About 5 grams of zinc oxide nanoparticles (sub 50 nanometer crystallite size) were dispersed in 150 grams of distilled water and 7.9 grams of silver nitrate (>99.9% purity). Next 2 drops of BYK022® (BYK Chemie, Germany) were added to the mixture. After stirring for 15 minutes, 50 ml of formaldehyde was added which caused immediate formation of a brownish precipitate. The solid was dried at 110° C. for 30 minutes. About 6.2 grams of powders were recovered. The powder was analyzed with X-ray diffractometer and strong silver metal peaks were seen. This example illustrates that silver coated zinc oxide nanoparticles can be prepared using precipitation techniques as well.

### EXAMPLE 11

### Silver Comprising Zinc Oxide Nanoparticles

Zinc oxide nanopowders were prepared using the process described herein and the cited commonly owned patents. These are commercially available from NanoProducts Corporation as PureNano™ zinc oxide nanoparticles. About 10 grams of zinc oxide nanoparticles (sub 50 nanometer crystallite size) were dispersed in 400 grams of distilled water and 28.3 grams of silver nitrate (>99.9% purity). The powder was stirred for about 12 hours and then filtered. The filter cake was dried at 110° C. for 45 minutes. About 9.8 grams of grey-blue powders were recovered. The powder was analyzed with X-ray diffractometer and surprisingly, strong silver oxide peaks were seen. This example illustrates that nanoparticles can be useful reagents to prepare unusual compositions of matter. Silver oxide coated zinc oxide nanoparticles can be prepared. The silver oxide coated zinc oxide powders were heated at 200° C. for 90 minutes and then at 300° C. for 60 minutes. This converted silver oxide coated ceramic nanopowder into silver coated ceramic powder.

### EXAMPLE 12

### Silver Coated Zinc Oxide Particles

Zinc oxide powders—Zinvisible™ powders—were purchased from Zinc Corporation of America. 5 grams of zinc oxide particles (Zinvisible) were mixed with 10.4 grams of glycerol and 6.3 grams of silver nitrate (99.9%+purity). TGA of fresh sample shows decomposition to Ag/ZnO is complete at 350 C with two significant weight losses at 130 C and 280C. The mix was first heat treated for 1 hour at 250° C. to evaporate the solvents and melt the silver nitrate so as to enable it to wet the powders. The powders were cooled, ground in a pestle and then heated to 500° C. to decompose silver nitrate to silver. About 8.8 grams of submicron powders were recovered. TGA was also done on this powder sample, showing a weight loss of 1.2 wt % at 990 C. The powder was analyzed with X-ray diffractometer and strong silver metal peaks were seen. The surface area of the powder was found to be greater than 6 m²/gm by 5 point BET method. Imaging analysis using high resolution transmission electron microscope showed a mixture of nanoparticles and submicron particles with silver. No atomic disorder was observed. The powders were found to be electrically conductive. This example illustrates that silver coated zinc oxide particles can be prepared regardless of the method used to prepare the particles.

Silver coated nanoparticles with high available surface area produced in this example and broader teachings herein are excellent broadband anti-microbials, anti-fungal, anti-bacterial agent. They can applied as coatings or additives or in creams or as part of bandages to treat infected part or wounds to prevent infection.

While the present invention has been shown and described herein in what is believed to be the most practical and preferred embodiments, it is recognized that modifications can be made within the scope of the invention, which is therefore not to be limited to the details disclosed herein. Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

1. An anti-microbial composition comprising
silver comprising particles;
wherein at least 25% by weight of the silver comprising particles are substantially free of atomic disorder; and wherein the silver comprising particles comprise particles with a domain size less than the nano-solvation diameter.

2. The composition of claim 1, wherein the silver comprising particles are coated particles.

3. The composition of claim 1, wherein at least 50% by weight of the silver comprising particles are substantially free of atomic disorder.

4. The composition of claim 1, wherein at least 75% by weight of the silver comprising particles are substantially free of atomic disorder.

5. The composition of claim 1, wherein at least 90% by weight of the silver comprising particles are substantially free of atomic disorder.

6. The composition of claim 1, wherein the nano-solvation diameter is less than 125 nanometers.

7. The composition of claim 1, wherein the nano-solvation diameter is less than 85 nanometers.

8. The composition of claim 1, wherein the nano-solvation diameter is less than 40 nanometers.

9. The composition of claim 1, wherein the nano-solvation diameter is less than 10 nanometers.

10. A fabric comprising the anti-microbial composition of claim 1.

11. A bandage comprising the anti-microbial composition of claim 1.

12. A leather product comprising the anti-microbial composition of claim 1.

13. A baby-care product comprising the anti-microbial composition of claim 1.

14. A consumer product comprising the anti-microbial composition of claim 1.

15. A laundry product comprising the anti-microbial composition of claim 1.

16. A cream comprising the anti-microbial composition of claim 1.

17. A resin comprising the anti-microbial composition of claim 1.

18. A coating comprising the anti-microbial composition of claim 1.

19. An adhesive comprising the anti-microbial composition of claim 1.
